(19) United States
(12) Patent Application Publication
(10) Pub. No.: US 2005/0141770 A1
(43) Pub. Date: Jun. 30, 2005

(54) Split on-screen keyboard

(75) Inventors: Juha Marila, Rauma (FI); Vuokko Lantz, Vantaa (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/749,813

(22) Filed: Dec. 30, 2003

(51) Int. Cl. G06K 9/72

(52) U.S. Cl. 382/230; 382/229

(57) ABSTRACT

A device and method for inputting information is disclosed. The device comprises a display, such as a touch-sensitive display, and a memory. The memory comprises a first set of characters, said first set of characters comprising at least two characters, and a second set of characters, said second set of characters comprising at least two characters. The characters in the first set of characters are statistically more likely to be selected in successive order than the characters in the second set of characters. The display is adapted to display, for selection of which character to input, the first set of characters.

### TECHNICAL FIELD

The present invention generally relates to displays with on-screen keyboards, such as touch-sensitive displays, and more specifically to a method and device for enabling a user of such a display to faster and more accurately input text into the device by means of an on-screen keyboard.

### BACKGROUND OF THE INVENTION

On handheld devices using touch screens as input devices text is often input by tapping graphical icons or images of characters on the screen with a pen, stylus or the like. Characters are often arranged in the same layout and order as keys on a standard QWERTY keyboard. This is, however, not the best solution for small screen devices since the size of each individual virtual key is depending on the overall size of the display and hence normally becomes quite small.

The well known Fitts' Law, which concerns human manual motor performance for various pointing tasks, states that as targets of hand movements get smaller and spaced further apart, the time needed for moving from one target to another increases, or the target hitting precision decreases. The amplitude of an aimed movement is, according to Fitts' law, analogous to an electronic signal, and the spatial accuracy of the move is analogous to electronic noise. More specifically, Fitts' Law relates to a serial, or reciprocal, target acquisition task, wherein a person alternately taps on targets of width W separated by a distance D. Fitts' law then proposes a quantification of the difficulty of a target acquisition task called the index of difficulty (ID) which is calculated according to the formula:
ID=log₂(2D/W)

Thus, according to Fitts' Law, decreased key size results in slower typing speed or in increased probability of typing errors.

Many attempts to overcome the difficulties of entering text on small-size devices without the need for a separate keyboard have been proposed in the art. One approach is to try to predict the next letter to be entered by studying patterns, such as digrams (sometimes referred to as bigrams) or trigrams of the language used for entering text, and in some way indicate or emphasize the next character to be entered.

U.S. Pat. No. 5,963,671 discloses an on-screen keyboard where the most likely to be used characters and controls of the keyboard are determined from consulting trigram tables. The letters and other characters of the keyboard can be arranged in a standard keyboard format or an entirely different arrangement such as strings of letters and numbers in alphabetical and numerical order. An attractant, such as color intensity or size, is used for emphasis to make a keyboard user cognizant of the location of the subset of characters that the user is most likely to select. Where the most likely character is a letter, duplicates of other letters of the subset, symbols identifying control functions for selection, and probable multi-letter combinations, including full words and word endings, can be clustered around that most likely to be selected letter. However, the change of the size of the most likely character to be selected is likely to confuse a user due to the varying layout on the screen (different characters are enlarged at different time instants). Moreover, the solution according to U.S. Pat. No. 5,963,671 is also confusing for the user in that the keyboard layout is dynamically changed as the user enters characters. In particular, the relative position of the character key centers alters based on the prediction of the next character to be entered.

Another approach is presented in U.S. Pat. No. 5,812,117 which discloses a portable information terminal adopting a soft keyboard and including a screen display device for receiving screen data relating to the soft keyboard and displaying the soft keyboard on the display screen. The soft keyboard includes an information key region where the information keys of a predetermined number are arranged in two lines or less, and a scroll key region where one or more scroll direction keys are displayed for scrolling the information keys to select the information keys displayed on the information key region. The division of characters to be displayed on the screen according to U.S. Pat. No. 5,812,117 is however not optimized, i.e. the user has to scroll the information key region back and forth very often when inputting text if the next character to be entered is not present in the currently displayed set of characters. Hence, the soft keyboard according to U.S. Pat. No. 5,812,117 does not provide a user of the device with a fast and efficient way of inputting text even though the keyboard may be displayed on small devices.

Finally, according to a specialized area of motor behavior known as bimanual control or laterality, humans are not only two-handed, but also use their hands differently. A study of the distribution of labor between the hands in everyday tasks reveals that most tasks are asymmetric, i.e. our hands have different roles and perform distinctly different tasks. The well known Guiard's model of bimanual skill identifies the roles and actions of the so-called non-preferred and preferred hands. More specifically, according to Guiard's model the non-preferred hand leads the preferred hand, sets the spatial frame of reference for the preferred hand, and performs coarse movements, while the preferred hand follows the non-preferred hand, works within the established frame of reference set by the non-preferred hand, and performs fine movements. Consequently, an input device of a fixed, limited size should preferably take into account not only the relationship between the width and distance between the keys as mentioned above, but also which hand is to perform the specific tasks related to inputting text by means of a touch-screen.

### SUMMARY OF THE INVENTION

An object of the present invention is to overcome the above described problems of the known technologies in regard to providing a fast and efficient way of inputting information, such as text, into an electronic device by means of a limited-sized display, such as a touch-sensitive display, with an on-screen keyboard. The present invention is based on the understanding that by dividing the character set of a large virtual keyboard into smaller subsets based on the statistical probability of selecting a specific character and displaying the subsets separately on a display in the device, a user of the divided keyboard will be provided with larger individual keys while still being able to most likely find the next desired character to be entered in the currently displayed subset.

Particular advantages of the present invention are fast and efficient inputting of characters into the device, low demands for processing capabilities in the device, and low demands on memory requirements. A further advantage of the invention is the possibility to reduce the size of the display in the device.

The above objects, advantages and features together with numerous other objects, advantages and features, which will become evident from the detailed description below, are obtained according to the present inventive concept by a device for inputting information comprising:
a display;
a memory comprising a first set of characters, said first set of characters comprising at least two characters, and a second set of characters, said second set of characters also comprising at least two characters, wherein the characters in the first set of characters are statistically more likely to be selected in successive order than the characters in the second set of characters; and
wherein said display is adapted to display, for selection of which character to input, the first set of characters.

The displayed characters may hence be increased in size due to the reduced number of characters presented simultaneously on the display. The rate at which the characters may be entered is moreover increased due to the increased statistical possibility of finding a desired character in the displayed set of characters. Alternatively, the reduction of the number of characters presented simultaneously on the display may be used for presenting other information than characters in subareas of the display that are made available thanks to the reduced number of characters. Whether to increase the character size thanks to the reduced number of characters, or to maintain the character size and instead use available subareas of the display for presentation of non-character information, may be a user-selectable option.

The display may be adapted to display additional characters in addition to the first set of characters, e.g. control keys such as a delete key.

The device may be adapted to select any desired one of the displayed characters if said desired character exists in the displayed first set of characters. To this end, the display may be a touch-sensitive display, wherein the selection of said desired displayed character is performed by detecting a selecting action applied onto the surface of the display by a user's pen, stylus, finger, etc. In other embodiments, the display is not a touch-sensitive display, and the selection of said desired displayed character is performed through other input means, such as a joystick or a rotator, by way of which the user may scroll through the displayed first set of characters and select a currently marked one of the characters at his or her desire.

The device may be adapted to replace, on the display for selection, the first set of characters with the second set of characters if a desired character does not exist in the displayed first set of characters.

The device may be adapted to select any desired one of the displayed characters if said desired character exists in the displayed second set of characters.

The device may comprise a character set switch for replacing the currently displayed set of characters with another set of characters. In one embodiment, the character set switch is a hard key or other hardware member, separate from said display. In another embodiment, the character set switch is represented by a selectable element on said display, for instance one of the characters of aforesaid additional characters which are displayed in addition to the first set of characters, or by the display being responsive to a predetermined pen/finger gesture or stroke.

The first set of characters and the second set of characters may be based on a specific language used for inputting information.

The characters in the first set of characters being statistically more likely to be selected in successive order than the characters in the second set of characters means that for each of said at least two characters in the first set of characters, there is at least one other character, among said at least two characters in the first set of characters, which has a high likelihood of being selected by a user either directly before or directly after the character in question, compared to a corresponding successive selection of a first and a second character among said at least two characters in the second set of characters. The decision as to which characters to include in the first set of characters may be based on digrams, trigrams or any other statistical pattern for the specific language used for inputting information.

Not all ordinary text characters in the specific language used for inputting information must be included in either of the first and second character sets. Thus, in some instances certain ordinary text characters may be displayed simultaneously with the first set of characters, even if such certain characters are not statistically “qualified” for this, and vice versa.

The above objects are obtained according to the present inventive concept by a method for inputting information using a display, the method comprising:
defining a first set of characters comprising at least two characters;
defining a second set of characters comprising at least two characters,
wherein the characters of the first set of characters are statistically more likely to be selected in successive order than the characters of the second set of characters; and
displaying, for selection of which character to input, the first set of characters on the display.

The method may comprise selecting any desired one of the displayed characters if said desired character exists in the displayed first set of characters.

The method may comprise replacing, on the display for selection, the first set of characters with the second set of characters if the desired character does not exist in the displayed first set of characters.

The method may comprise selecting any one of the displayed characters if the desired character exists in the displayed second set of characters.

The method may define the first set of characters and the second set of characters based on a specific language used for inputting information.

The above objects are obtained according to the present inventive concept by software product stored in a memory for generating a virtual keyboard on a display, the software product comprising:
software code for defining a first set of characters comprising at least two characters;
software code for defining a second set of characters comprising at least two characters,
wherein the characters of the first set of characters are statistically more likely to be selected in successive order than the characters of the second set of characters; and
software code for displaying, for selection of which character to input, the first set of characters on the display.

The software product may comprise software code for selecting any desired one of the displayed characters if said desired character exists in the displayed first set of characters.

The software product may comprise software code for replacing, on the display for selection, the first set of characters with the second set of characters if a desired character does not exist in the displayed first set of characters.

The software product may comprise software code for selecting any one of the displayed characters if the desired character exists in the displayed second set of characters.

### BRIEF DESCRIPTION OF THE DRAWINGS

Further objects, features and advantages of the present invention will become apparent upon consideration of the following detailed description in conjunction with the appended drawings.

FIG. 1 is a schematic illustration of an electronic device using the virtual keyboard according to the present inventive concept.

FIG. 2a is a schematic illustration of a first grouping of characters according to a first aspect of the present inventive concept.

FIG. 2b is a schematic illustration of a second grouping of characters according to a second aspect of the present inventive concept.

FIG. 2c is a schematic illustration of a third grouping of characters according to a third aspect of the present inventive concept.

FIG. 3 is a schematic illustration of a fourth grouping of characters according to a fourth aspect of the present inventive concept.

FIG. 4 is an illustration of a device in which the present inventive concept may be used.

FIG. 5 illustrates a flow chart for inputting information according to the present inventive concept.

### DETAILED DESCRIPTION OF THE INVENTION

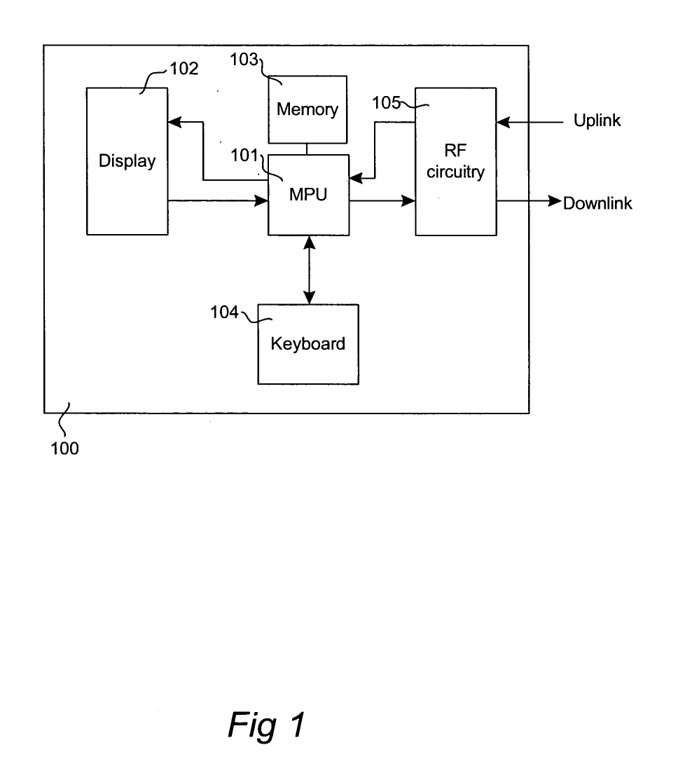

A device in which the present inventive concept may be applied will first be described with reference to FIG. 1. Then the particulars of the device according to the present inventive concept will be described with reference to the remaining figures.

FIG. 1 illustrates a device 100 comprising various parts known per se. More specifically the device 100 comprises a Micro Processing Unit (MPU) 101 or a microcontroller which may be in form of any suitable MPU, such as an AVR RISC microcontroller from Atmel Corporation, 2325 Orchard Parkway, San Jose, Calif. 95131, USA; a processor in the PIC-processor family from Microchip Technology Inc, 2355 West Chandler Blvd, Chandler, Ariz., USA or a processor that is specifically designed for use in the device 100. The latter approach is beneficial in that the MPU 101 may then be integrated with other devices on a single chip in the device 100 wherein the overall size of the device 100 may be reduced. Due to the large selection in the field of micro processor technology in regard to processing capabilities, energy consumption, size and memory management capabilities, a person skilled in the art will find no difficulties in selecting a suitable micro processing unit 101 for performing the tasks associated with the appended claims.

The MPU 101 is connected to a touch-sensitive display 102 which may be of an analog resistive type, capacitive type, acoustic wave type, electromechanical type or any other suitable type being sensitive to pressure exerted on the surface thereof. The communication between the MPU 101 and the display 102 is hence bidirectional; the MPU 101 provides the display 102 with information that is to be presented to the user of the device 100, whilst the display 102 provides data to the MPU 101 indicating if and where a touch on the screen has been performed. As will be disclosed in more detail below, an application program executed in the MPU 101 may then use this data for performing specific tasks.

The MPU 101 is moreover connected to a memory 103. The memory 103, which may be in form of e.g. a ROM, PROM, SRAM, DRAM, EPROM, EEPROM, FLASH, NVRAM or any other suitable form of memory, is illustrated as a separate unit in FIG. 1, but may as well be integrated in the MPU for minimizing the size of the device 100 as well as for lowering the manufacturing costs of the device 100. The memory 103 comprises program code which when executed in the MPU 101 performs various tasks. One task to be performed when executing part of the program code stored in the memory 103 is to support the basic input/output capabilities of the device 100, i.e. provide the services associated with an ordinary operating system. More application specific tasks to be performed by the MPU 101 when executing other parts of the program code stored in the memory 103 will be disclosed in detail below. Besides storing code to be executed in the MPU 101, the memory 103 also comprises data related to the frequency of leading digrams found in the language being used for presenting and receiving information to and from the user of the device 100. In case the device 100 is supporting more than one language, which is common in e.g. the field of mobile telecommunication, the memory 103 comprises data related to the frequency of leading digrams found in all possible languages being supported by the device 100.

The MPU 101 may also be connected to a hardware keyboard 104, or rather a set of hardware keys, comprising one or more keys. An exemplary keyboard may comprise two scroll keys for scrolling text and images on the display 102 and one or more keys for initiating specific applications on the device 100, e.g. a calendar program or a phone book. The keyboard may also be in the form of a complete numerical keyboard found on many mobile telephones today. In case the device 100 is designed to be very small the keyboard may be omitted, wherein the input of information into the device 100 is solely performed by means of the touch-sensitive display 102.

The device 100 may of course comprise further components depending on the specific intended use of the device 100. As an example, as illustrated in FIG. 1, the device 100 may comprise RF-circuitry 105 for providing mobile telecommunications capabilities. More specifically, the device 100 may be in the form of a mobile terminal suitable for use in any mobile telecommunications system, such as GSM, GPRS, DAMPS, DCS, PCS, or UMTS. Other possible components to include in the device 100 are digital cameras, music players, voice recorders etc.

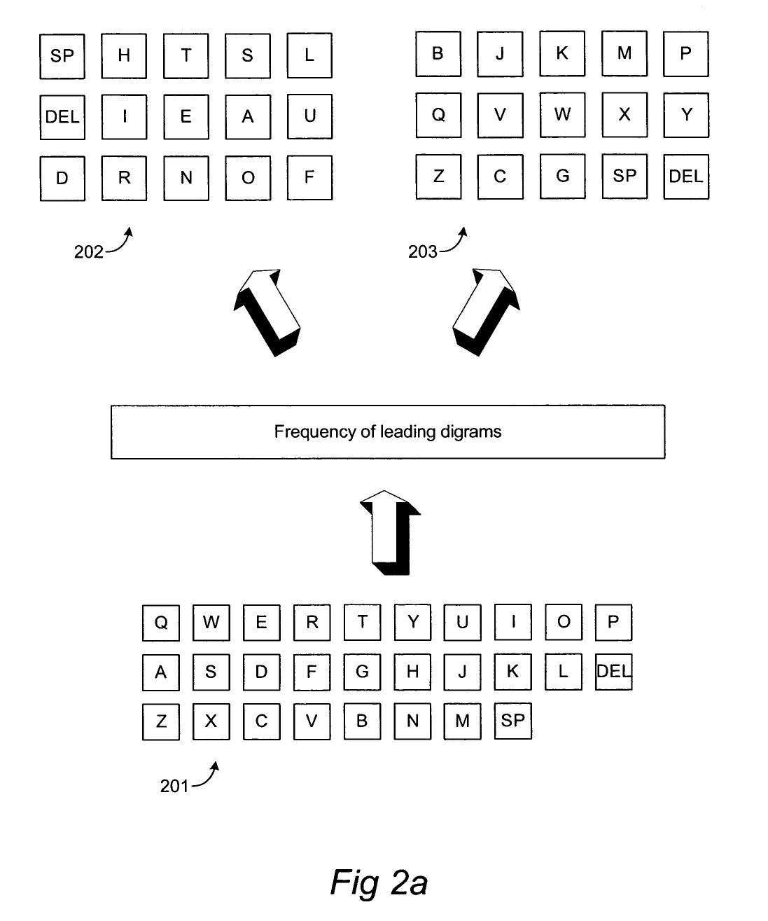

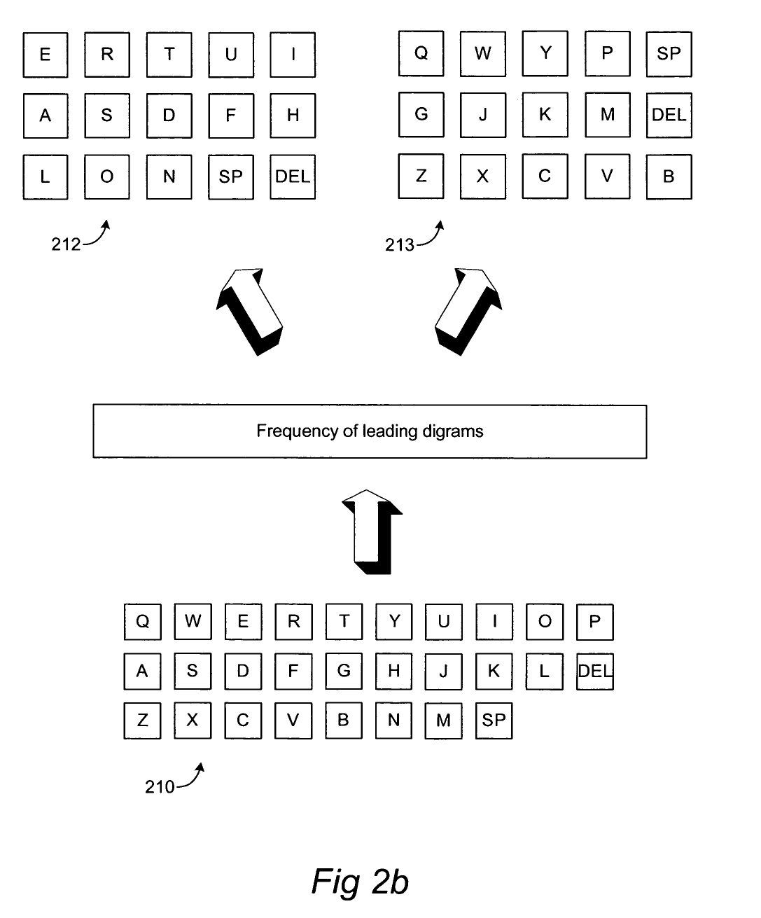

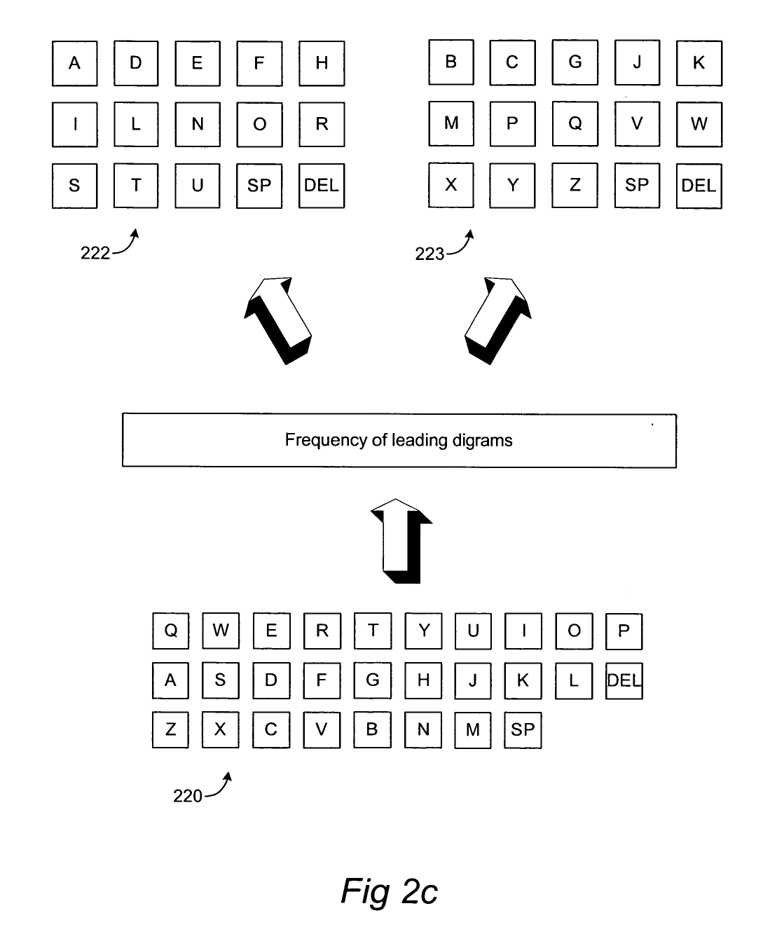

FIG. 2a illustrates a first, preferred aspect of the present inventive concept. A first, schematically illustrated virtual keyboard 201 comprises characters found in the English language as well as an additional space (SP) and delete (DEL) key. As mentioned above, a problem with the large keyboard 201 is that it is too large to be used efficiently on a small display 102, i.e. the individual keys of the keyboard 201 will become too small if the entire keyboard 201 is to be shown on the display 102. Instead of showing the entire keyboard 201 the virtual keyboard 201 is divided into two halves 202, 203 so as to increase the size of the individual characters on the keyboards 202, 203. The optimal division of the character set is defined by the language used for inputting text. The possible divisions are preset in the device 100, using an algorithm stored in the memory 103 that minimizes the probability of keyboard switching in each desired language based on the digram frequencies for each language used.

The digram frequencies needed by the optimization algorithm are derived from a large database containing text samples of the language in question. More specifically, as the large database is traversed, successive digrams are analyzed so as to determine how often each and every digram appears in the database. Each digram may thereafter be weighted in relation to all digrams found in the database indicating the frequency of occurrence in the database. As an example, according to H. F. Gaines, Cryptanalysis; a study of ciphers and their solution, Dover, N.Y., 1956, the statistically most common digrams in the English language are (in order): TH, HE, AN, IN, ER, RE, ES, ON, EA, TI, AT, ST, EN, ND, OR, TO, NT, ED, IS, AR, OU, TE and OF.

As seen from FIG. 2a the optimization algorithm produces two keyboard layouts, wherein the leftmost keyboard 202 comprises the characters found in the statistically most common digrams, while less common digram characters are found in the rightmost keyboard 203. As can be understood from FIG. 2a, a device 100 comprising a display 102 of a fixed, limited size will benefit from using the splitting technique described above in that a user of the device 100 will be provided with larger virtual keys than in the prior art solutions while still maintaining a high possibility of finding the next desired character in the set of characters displayed on the display 102.

Normally characters are entered by using a pen, stylus or the like for tapping the desired character on the display 102. The layout of the characters in each character set can then, as seen in FIG. 2a, be optimized for shortest expected pen movement. More specifically, by analyzing the digrams used for providing the divided character sets 202, 203 it is possible to arrange the characters in each set 202, 203 so that each character of the digrams in question is arranged as close as possible to the other character in same digram. By comparing FIG. 2a with the statistically most common digrams in the English language disclosed above it is found that within the leftmost character set layout 202, the letter T is arranged next to the letter H, the letter H is arranged next to the letter E, the letter A is arranged next to the letter N, the letter I is arranged next to the letter N, and so on. Thus, the characters within the divided character sets 202, 203 are clustered, so that characters that are statistically more likely to be selected in successive order appear closer to each other on the display than characters that are statistically less likely to be selected in successive order.

Hence, a user of the divided keyboard according to FIG. 2a will not only be provided with larger individual keys due to the division of the large keyboard 201, he will also be provided with a keyboard layout 202, 203 that minimizes the switches between the different character sets and a keyboard layout that minimizes the pen movement within the currently displayed character set 202, 203. As disclosed above, according to Fitts' law the difficulty of the movement task will be reduced as the target size increases and the distance between the targets decreases. Consequently, the enlarged keys and the close spacing between digram keys within a displayed character set will significantly increase the typing speed and decrease the probability of typing errors performed by the user of the device 100.

FIG. 2b illustrates another grouping of characters according to a second aspect of the present inventive concept. Instead of arranging the characters in accordance with the teachings of Fitts' law the characters found in the divided character sets 212, 213 are arranged in similarity with an ordinary QWERTY keyboard 210. As can be seen in the figure the leftmost character set 212 still comprises the characters found in the statistically most common digrams of the language used in the device 100, while less common characters are found in the rightmost character set 213. It is however appreciated that the top rows of the character sets 212, 213 correspond, as far as possible with the reduced number of characters, to the top row of an ordinary QWERTY keyboard. The other rows in the divided character sets 212, 213 likewise correspond to the other rows of the QWERTY keyboard 210. By arranging the characters in similarity to an ordinary QWERTY keyboard a user of the device, who is familiar with the QWERTY keyboard, may find it easier, at least initially, to use a keyboard layout 212, 213 that corresponds as much as possible to the larger keyboard 210. The distance-optimized keyboards 202, 203 will, however, pay back in time by enabling higher typing speed as the user learns the splitting and layout of the key set.

FIG. 2c illustrates yet another keyboard layout 222, 223 of the divided QWERTY keyboard 220. In this layout the leftmost character set 222 still comprises the characters found in the statistically most common digrams of the language used in the device 100, while less common characters are found in the rightmost character set 223. The individual characters within each character set 222, 223 are however sorted alphabetically. Users who are not familiar with the QWERTY keyboard layout 220 may find this familiar sorting of characters convenient to use.

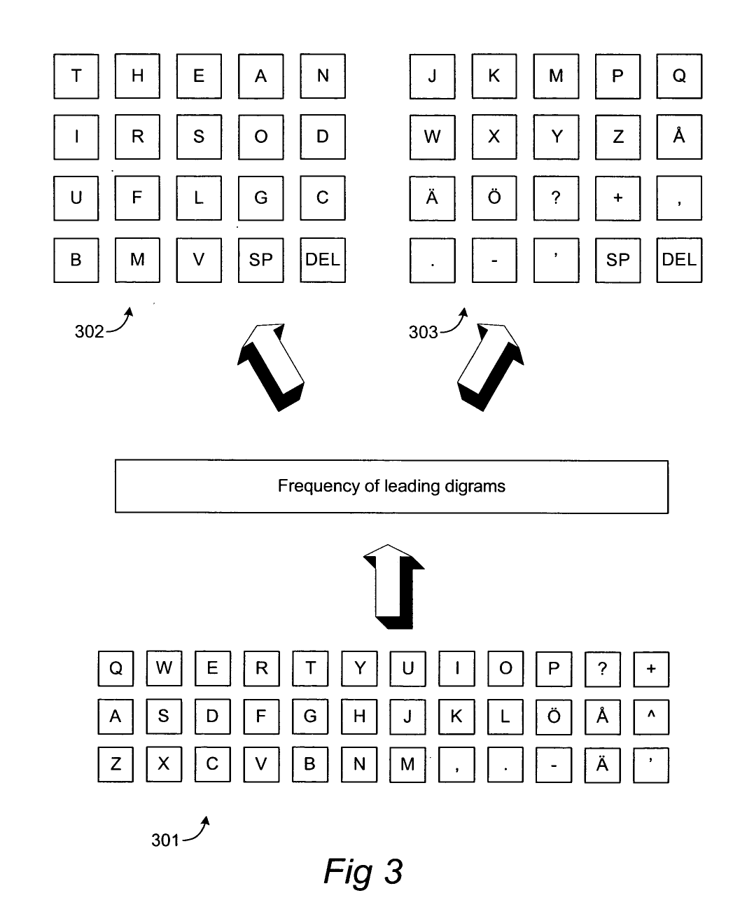

As mentioned above, for the English language, two 5-by-3 key grids can fit all the commonly used alphabetical letters: 13 letters, space, and delete keys can be assigned to both keyboard halves. For other languages, also based on Latin characters but having more than 26 letters, the other keyboard half may contain some letters, such as ü or B instead of the space and delete keys. Another approach, illustrated in FIG. 3, is to add a fourth row of characters, i.e. use 5-by-4 key grids for the keyboard halves. Special characters, such as Å, Ä, and Ö in e.g. the Swedish language, will then fit into the divided keyboard layouts 302, 303. In this case, the total height of the virtual keyboards 302, 303 are increased or the individual keys are shrunk vertically. The arranging of the individual keys within each character set 302, 303 is similar to the arrangements disclosed in relation to FIGS. 2a-2c. The leftmost character set 302 in the figure will in this embodiment comprise characters from statistically common digrams hence increasing the possibility for the user of the device 100 to find the next desired character within this character set 302. The switching between character sets 302, 303 is hence reduced even further.

If the display is very small or if the number of characters used in the device 100 is large, it is possible within the scope of the present inventive concept to divide the large virtual keyboard 201 into three or more sets of characters. The number of switches between the different character sets will then increase, but given the circumstances it may still be desirable to use large keys which compensates for the increased number of switches.

Returning shortly to FIGS. 1 and 2, a dedicated physical key on the hardware keyboard 104 may be used for enabling the user of the device 100 to switch between the character sets 202, 203. The hardware key may be a scroll key or a application-specific key on the device 100, e.g. a key initiating a calendar program or a phone book. The key used for switching between the character sets 202, 203 may also be a graphical button on the touch screen, or a gesture performed on the touch screen, e.g. sweeping a pen or a finger across the display 202. Moreover, the switching between character sets 202, 203 can be done by either pressing and releasing the dedicated key, or by pressing and holding the key for displaying the second character set 203, wherein the first character set 202 is displayed when the key is released. Preferably the device 100 is designed so as to allow a user of the device 100 to use one hand for pointing at keys of the displayed set of characters 202, 203 and the other hand for switching between character sets 202, 203, i.e. use the other hand for controlling the switching key.

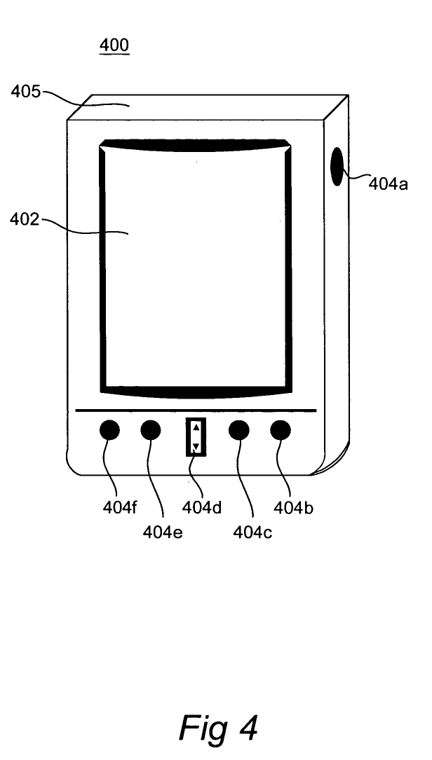

FIG. 4 illustrates such a device 400, in which the present inventive concept may be used. The device 400 comprises a display 402 and a keyboard 404a-f. Some of the keys 404b, 404c, 404e, 404f may be used for initiating specific applications in the device, while one key 404d, or rather two keys combined to one larger key, is dedicated for scrolling text and images on the display 402. Besides the application-specific keys 404b, 404c, 404e, 404f and the scroll key 404d, the device 400 also comprises a key 404a arranged on the side thereof, which may be used for switching between different character sets 202, 203. The teachings of bimanual control mentioned above apply well to the device 400, wherein the division of tasks between hands may easily be performed, i.e. pointing keys with the preferred hand and switching between character sets 202, 203 with the non-preferred hand. Not shown in the figure are the MPU 101 and the memory 102 which reside inside the housing 405 of the device 400. It is obvious that the device 400 may comprise additional electric circuitry for performing specific tasks, e.g. RF-circuitry for providing mobile telecommunications capabilities.

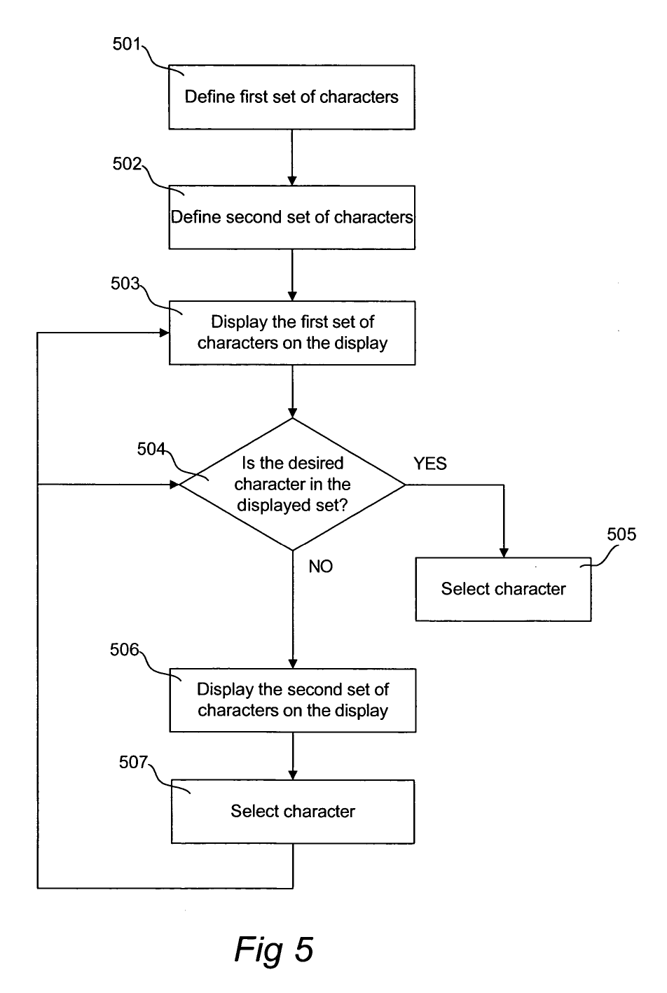

FIG. 5 illustrates a flowchart for inputting information using a touch-sensitive display by performing the selection of a desired character from the different set of characters 202, 203. Reference will also be made to the other figures in order to facilitate the understanding of the present inventive concept.

The routine starts by defining 501 the first set of characters being part of statistically common digrams in the language used in the device 100. The number of characters defined to be part of the first set of characters depend on, besides the language used, the number of character sets to use as well as the size of the display. The characters belonging to the first set of characters are, as mentioned above, derived from a large database containing text samples of the language in question and are pre-stored in the memory 103. Each character stored in the memory 103 may be linked to a specific digram frequency for each and every language to be used, or the memory may be divided into separate areas for different languages, each comprising the first and second predetermined set of characters to be used. Irrespectively of the technique used for dividing and storing the characters in the memory 103, each character is accessible by the MPU 101 which is arranged to define which set of characters the accessed character shall belong to for presentation on the display 102. There is hence no need to store large databases containing text samples of different languages in the memory 103.

The routine then continues by defining 502 the second set and, if desired, any additional sets of characters to be used.

In step 503 the MPU 101 provides the display 102 with the first set of characters for enabling the user of the device 100 to select a desired character. It is appreciated that even though it is preferable to initially display the first set of characters 202, it is equally possible to initially display the second set of characters 203 albeit it is most likely that the desired character is found in the first set of characters 202.

In step 504 it is determined if the desired character is part of the displayed set of characters. If so, the routine jumps to step 505, wherein the desired character is selected by touching the screen at the location where the character is displayed.

If the desired character is not part of the displayed set of characters, the routine jumps to step 506, wherein the user switches from the first set of characters 202 to the second set of characters 203 by e.g. pressing a key 404a on the device 400, or a virtual switch key being part of the first set of characters 202 on the display.

In step 507 the user of the device 400 finally selects the desired character. The routine may thereafter stop if all desired characters have been entered, or the routine may jump back to step 503 for displaying the first set of characters on the display 102 thereby enabling the user of the device 400 to select a character from the first set of characters 203, or jump to step 504 for enabling the user of the device 400 to select yet another character from the second set of characters 203.

Even though the present inventive concept has been disclosed in relation to the use of digrams, it is equally possible to use trigrams or any other statistical pattern for establishing a rule of division between a first set of characters 202 and a second set of characters 203. As an example it is possible to divide the character set of the large virtual keyboard 201 into two or more halves by using the order and frequency of single letters instead of digrams in the language used.

While the present inventive concept has been particularly shown and described with reference to specific embodiments thereof, it will be understood by those skilled in the art that various changes in form and detail may be made thereto, and that other embodiments of the present inventive concept beyond embodiments specifically described herein may be made or practiced without departing from the spirit and scope of the present inventive concept as limited solely by the appended claims.

1. A device for inputting information, comprising:
a display; and
a memory comprising a first set of characters, said first set of characters comprising at least two characters, and a second set of characters, said second set of characters comprising at least two characters,
wherein the characters in the first set of characters are statistically more likely to be selected in successive order than the characters in the second set of characters, and
wherein said display is adapted to display, for selection of which character to input, the first set of characters.

2. The device of claim 1 adapted to select any desired one of the displayed characters if said desired character exists in the displayed first set of characters.

3. The device of claim 1 adapted to replace, on the display for selection, the first set of characters with the second set of characters if a desired character does not exist in the displayed first set of characters.

4. The device of claim 3 adapted to select any desired one of the displayed characters if said desired character exists in the displayed second set of characters.

5. The device of claim 1 comprising a character set switch for replacing the currently displayed set of characters with another set of characters.

6. The device of claim 1 adapted to cluster, on the display for selection, characters within the first set of characters, so that characters that are statistically more likely to be selected in successive order appear closer to each other than characters that are statistically less likely to be selected in successive order.

7. The device of claim 1 adapted to display the characters in the first set of characters on the display in QWERTY-format.

8. The device of claim 1 adapted to display the characters in the first set of characters on the display in alphabetical order.

9. The device of claim 1, wherein said display is a touch-sensitive display.

10. The device of claim 1, wherein the first set of characters and the second set of characters are based on a specific language used for inputting information.

11. The device of claim 1, embodied as a mobile terminal for a mobile telecommunications system.

12. A method for inputting information using a display, the method comprising:
defining a first set of characters comprising at least two characters;
defining a second set of characters comprising at least two characters,
wherein the characters of the first set of characters are statistically more likely to be selected in successive order than the characters of the second set of characters; and
displaying, for selection of which character to input, the first set of characters on the display.

13. The method of claim 12 comprising:
selecting any desired one of the displayed characters if said desired character exists in the displayed first set of characters.

14. The method of claim 12 comprising:
replacing, on the display for selection, the first set of characters with the second set of characters if a desired character does not exist in the displayed first set of characters.

15. The method of claim 14 comprising:
selecting any one of the displayed characters if the desired character exists in the displayed second set of characters.

16. The method of claim 12, wherein the step of defining the first set of characters and the second set of characters are based on a specific language used for inputting information.

17. The method of claim 12 comprising:
clustering, on the display for selection, characters within the first set of characters, so that characters that are statistically more likely to be selected in successive order appear closer to each other than characters that are statistically less likely to be selected in successive order.

18. The method of claim 12 comprising
displaying the characters in the first set of characters on the display in QWERTY-format.

19. The method of claim 12 comprising
displaying the characters in the first set of characters on the display in alphabetical order.

20. The method of claim 12 performed in a mobile terminal for a mobile telecommunications system.

21. A software product stored in a memory for generating a virtual keyboard on a display, the software product comprising:
software code for defining a first set of characters comprising at least two characters;
software code for defining a second set of characters comprising at least two characters,
wherein the characters of the first set of characters are statistically more likely to be selected in successive order than the characters of the second set of characters; and
software code for displaying, for selection of which character to input, the first set of characters on the display.

22. The software product of claim 21 comprising:
software code for selecting any desired one of the displayed characters if said desired character exists in the displayed first set of characters.

23. The software product of claim 21 comprising:
software code for replacing, on the display for selection, the first set of characters with the second set of characters if a desired character does not exist in the displayed first set of characters.

24. The software product of claim 23 comprising:
software code for selecting any one of the displayed characters if the desired character exists in the displayed second set of characters.

25. The software product of claim 21 comprising:
software code for clustering, on the display for selection, characters within the first set of characters, so that characters that are statistically more likely to be selected in successive order appear closer to each other than characters that are statistically less likely to be selected in successive order.

26. The software product of claim 21 comprising:
software code for displaying the characters in the first set of characters on the display in QWERTY-format.

27. The software product of claim 21.comprising:
software code for displaying the characters in the first set of characters on the display in alphabetical order.

28. The software product of claim 21 stored in a memory in a mobile terminal for a mobile telecommunications system.
